(19) United States
(12) Patent Application Publication
(10) Pub. No.: US 2026/0251512 A1
(43) Pub. Date: Aug. 27, 2026

(54) MULTIPLE PIEZOELECTRIC YARN SLIDING SENSOR FOR WEAVING MACHINES AND METHODS FOR THE AUTOMATIC ASSEMBLY THEREOF

(71) Applicant: ROJ S.R.L., BIELLA (IT)

(72) Inventors: Luca BAGATIN, Biella (IT); Riccardo COMOTTO, Biella (IT); Carlo MILANACCIO, Biella (IT); Giacomo DALLE NOGARE, Biella (IT)

(21) Appl. No.: 19/489,652

(22) PCT Filed: May 30, 2024
(86) PCT No.: PCT/IB2024/055249

§ 371 Date: Dec. 3, 2025

(30) Foreign Application Priority Data
Jun. 7, 2023 (IT) 102023000011553

(51) Int. Cl. G01L 1/16; D05C 15/08

(52) U.S. Cl. CPC G01L 1/16; D05C 15/08

(57) ABSTRACT

A multiple piezoelectric yarn sliding sensor including a plurality of individual piezoelectric sensors, each including a piezoelectric element (P) stably associated with a yarn guide eyelet (4), an electronic printed circuit board (1) including flexible portions (2), onto which electrical signals emitted by the piezoelectric elements (P) of the individual piezoelectric sensors are conveyed through electrical connections, between the piezoelectric elements (P) and the electronic printed circuit board, including the flexible portions (2).

### FIELD OF INVENTION

The present invention refers to a multiple piezoelectric yarn sliding sensor for textile machines and to a related method for the automatic assembly thereof. This multiple piezoelectric yarn sliding sensor is used in most textile machines; an application of particular interest is in tufting textile machines where, in fact, it is necessary to simultaneously monitor a very large number of different yarns to then quickly identify with certainty any yarn breakages, to consequently stop the textile machine processing and repair the broken yarn. Piezoelectric yarn sliding sensors give a particularly satisfactory answer to this need, thanks to their small size and the possibility of being packed in groups at close distances without creating mutual interference. The following description of the multiple piezoelectric yarn sliding sensor of the invention will however be given with exclusive reference to such multiple piezoelectric sensors, whose intrinsic features are in fact completely independent of the specific textile machine it is used in.

### BACKGROUND OF THE PRIOR ART

Piezoelectric yarn sliding sensors exploit the well-known feature of piezoelectric materials-such as some ceramic materials having this peculiar property of generating a difference in electric potential between two positions at a certain mutual distance of a same element of said material, when such element is subjected to a mechanical stress. The difference in electrical potential that is thus generated between the two positions of said element can be detected and, by analysing this electrical signal, it is then possible to verify whether an element of piezoelectric material is in under a mechanical stress or instead at rest.

From a theoretical point of view, the application of this general concept to piezoelectric yarn sliding sensors is therefore relatively simple, as it is sufficient to rigidly associate a piezoelectric element of the above described type with a normal yarn guide eyelet inside which a yarn, whose regular sliding is to be checked, is passed, taking care to ensure that there is a continuous contact between the surfaces of the yarn guide eyelet and the yarn sliding therethrough. As a matter of fact, the sliding of the yarn thus causes a continuous mechanical stress, as vibrations, to the yarn guide eyelet and therefore to the piezoelectric element integral therewith. An electronic control circuit is connected to the piezoelectric element to detect whether there is a continuous electrical signal at its two poles, whose amplitude is greater than a predetermined threshold value. If so, there is confirmation of a regular sliding of the yarn, while when said electrical signal is absent or lower than said predetermined threshold value, this means that the vibration stress on the piezoelectric element ceased; therefore, the yarn which caused such vibration sliding through the yarn guide eyelet has evidently broken or jammed.

However, the practical implementation of this principle involved overcoming some difficulties, not only regarding the miniaturization of the yarn guide eyelets, which need in fact to have a sufficiently small mass to be set into vibration by the passage of a yarn therethrough, but above all regarding the mechanical support of the yarn guide eyelets and the electrical connection of the piezoelectric element. The mechanical support of the yarn guide eyelets should in fact allow their free vibration, dampening said vibration to the smallest possible extent; and the electrical connection between the two poles of the piezoelectric element and the relative electronic control board must be made with extremely thin and flexible conductors, again with the aim of not dampening the vibrations of the yarn guide eyelet/piezoelectric element assembly. As a matter of fact, a general principle applies according to which the more a yarn guide eyelet/piezoelectric element assembly is free to vibrate, the better the quality of the obtained signal, for the purposes of subsequent signal processing where the conditions of breakage or unexpected stopping of the yarns must be discriminated with the minimum possible error from the conditions of regular sliding.

In current methods of assembling piezoelectric yarn sliding sensors, each yarn guide eyelet and related associated piezoelectric element is arranged simply resting on a respective rubber seat which allows the yarn guide eyelet to vibrate to the greatest extent possible in its own way, in response to the stresses imparted by a yarn sliding therethrough. The two metallized poles of the piezoelectric element are then connected, by manual soldering, to two corresponding contact pads of an electronic printed circuit board (hereinafter also briefly indicated with the acronym PCB) which processes the electrical signals emitted by a plurality of said piezoelectric elements. For each mounted yarn guide eyelet, it is therefore necessary to carry out four manual soldering (two at the PCB side and two at the piezoelectric element side) using two conductors which must be as soft and flexible as possible, as already explained above.

The assembly method briefly described above is therefore particularly long and laborious and further requires the employment of highly specialized labour, both because it involves minute components and very thin and flexible conductors, and because, for obvious reasons of space saving, the yarn guide eyelets must be mounted at a very short mutual distance, transversally aligned in groups on respective support shells. The workspaces are therefore very limited.

EP-0139231 discloses a piezoelectric yarn sensor suitable for spinning and weaving machines which represents the prior art closest to the present invention, the features of which have been incorporated into the preamble to the independent claims of the present invention.

DE 2152907 discloses another type of yarn sensor for spinning and weaving machines, which uses an electroacoustic transducer to detect the yarn presence.

US-2022/0282416 discloses a system for monitoring yarn breakage in a textile machine.

In this background of the prior art, the technical problem addressed by the present invention is to provide a multiple piezoelectric yarn sliding sensor equipped with an innovative wiring system for the piezoelectric elements, which allows its manufacture with a fully automatic and rapid assembly method.

Within the context of this technical problem, a first object of the present invention is to provide a multiple piezoelectric yarn sliding sensor wherein manual soldering is no longer required for the wiring of the piezoelectric elements to the electronic board.

A second object of the present invention is then to provide a multiple piezoelectric yarn sliding sensor wherein the piezoelectric elements are mechanically connected to the PCB with a high degree of freedom to vibrate.

Finally, a third object of the present invention is to provide a multiple piezoelectric yarn sliding sensor wherein the wiring of the piezoelectric elements to the PCB can be quickly replaced by a flexible conductor with manual soldering in the event of breakages or failures of said wiring.

### SUMMARY OF THE INVENTION

This problem is solved, and these objects achieved, by means of a multiple piezoelectric yarn sliding sensor having the features defined in claim 1 and by a method of assembling said multiple piezoelectric sensors having the features defined in claim 10. Other preferred features of said multiple piezoelectric yarn sliding sensor and related assembly method are defined in the secondary claims.

### BRIEF DESCRIPTION OF THE DRAWINGS

Further features and advantages Of the multiple piezoelectric yarn sliding sensor according to the present invention will anyhow become more evident from the following detailed description of a preferred embodiment of the same, given by mere way of non-limiting example and illustrated in the accompanying drawings, wherein:

FIG. 1 is a front view of a rigid-flexible PCB suitable for the automatic soldering of multiple side by side piezoelectric elements;

FIG. 1A is an enlarged view of the end part of the PCB of FIG. 1;

FIG. 2 is a view similar to FIG. 1 with piezoelectric elements soldered onto the detachable flexible portions of the PCB;

FIG. 3 is a perspective view of the PCB in FIG. 2, wherein a respective yarn guide eyelet is glued on each piezoelectric element;

FIG. 4 is a perspective view of two PCBs and related batteries of yarn guide eyelets set in place in a respective support shell;

FIG. 5 is an enlarged perspective view of a yarn guide eyelet; and

FIG. 6 is an axial sectional view of the yarn guide eyelet of FIG. 5.

### DETAILED DESCRIPTION OF THE PREFERRED EMBODIMENT

According to the present invention, to solve the problem highlighted above with a constructively simple and immediately applicable solution, some substantial innovations have been introduced by the Applicant to the currently known assembly method illustrated in the introduction portion of the description, with the aim of making it completely automatic and therefore increase its output.

A first innovation concerns the use of flat piezoelectric elements with contact poles of the so-called “folded” or “wrapped” type. In this type of piezoelectric element-which is per se well known but not used in piezoelectric sensors until now-the two connecting metallized poles of the piezoelectric element are expected to be arranged on a same surface of the piezoelectric element, rather than on two opposing surfaces as it happens for the piezoelectric elements used in known piezoelectric yarn sliding sensors. This first innovation allows therefore to make the piezoelectric element easy to be automatically soldered to the PCB by use of surface mount technology (SMT).

A second innovation concerns then the use of a rigid-flexible or entirely flexible PCB, instead of a traditional rigid PCB; said definitions naturally referring to the mechanical features of the substrate on which the printed circuit is formed.

Traditional rigid PCBs are, in fact, typically composed of insulating layers and conductive layers, laminated together in a rigid substrate whereon the electronic components are mounted. The rigidity of such a substrate is mainly due to the use of rigid insulating layers typically composed of glass fibres impregnated with an epoxy resin. A consequent feature of rigid PCBs is their flatness; as a first approximation, rigid PCBs can therefore be considered as two-dimensional structures.

Rigid-flexible or entirely flexible PCBs are instead characterized by using substrates which have, by their true nature, a high degree of flexibility, so that they can be easily bent or curved, such as polyimide films. For this purpose, the use of rigid substrates which, if appropriately treated, can become deformable, even if only for a limited number of times, has also been proposed. Depending on the location and extension of the flexible substrate and rigid substrate portions, it is therefore possible to obtain completely flexible PCBs or PCBs including only some flexible portions in an otherwise rigid substrate.

Obviously, electrically conductive substrates can be integrated into both the rigid and flexible portions of the PCB, wherein electrical connections apt to connect different parts and components of the PCB are then defined, using per se known methods.

A typical feature of the said partially or fully flexible PCBs is the possibility of being placed not only in a two-dimensional plane, but also occupying the available space with a three-dimensional configuration.

According to the invention, the rigid-flexible or entirely flexible PCB is used by positioning the contact pads for electrical connection of the piezoelectric elements on a free end of a flexible portion of the printed circuit, the opposite end of which is joined to the PCB remaining part. Thanks to this special solution, after each piezoelectric element has been soldered to a respective flexible portion of the PCB, such piezoelectric element can freely vibrate and be conveniently placed with respect to the remaining part of the PCB, obviously within the limits of the length of said flexible portion, thus eliminating the pairs of conductors used in the prior art for electrical connection of the piezoelectric elements to the PCB.

Finally, a last innovation concerns the steps of assembling the different components of the multiple piezoelectric yarn sliding sensor, which are reversed compared to those of the traditional assembly method. In fact, while in this latter method a yarn guide eyelet/piezoelectric element assembly is first obtained by glueing, and then this assembly is soldered to the PCB, in the assembly method of the invention all the piezoelectric elements are first collectively soldered to the PCB and then the yarn guide eyelets are glued onto the piezoelectric elements already soldered to the PCB. In this way, all steps of the assembly method can be automated and thus achieve an output suitable to meet the needs of the market.

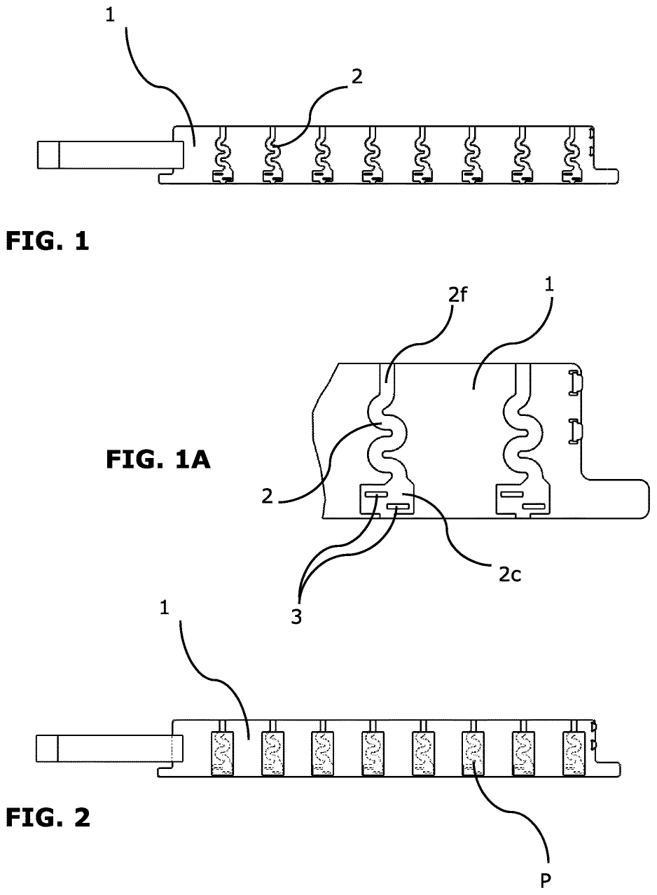

Referring now to the drawings, FIG. 1 schematically illustrates a rigid-flexible PCB 1 wherein electronic circuits collecting the electrical signals emitted by a certain number of side-by-side piezoelectric elements P are incorporated. The rigid substrate of the rigid-flexible PCB 1 is coated, in a per se known manner, by a flexible film which is then partially pre-cut in predetermined areas to form partially detachable flexible portions 2 of the rigid-flexible PCB 1. Components that must have a certain degree of freedom of positioning with respect to the rigid substrate of the rigid-flexible PCB 1 are then connected to said detachable flexible portions. Alternatively, fully or partially flexible PCBs can be used to achieve the same result.

FIG. 1A illustrates in greater detail the flexible portions 2 which are partially detachable from the rigid substrate of the rigid-flexible PCB 1, as they have a fixed end 2f firmly anchored to the rigid substrate of the rigid-flexible PCB 1 while being instead free to move with respect to said rigid substrate of the PCB for the remaining part, in particular as regards their free end 2c, opposite the fixed end 2f, on a surface of which two contact pads 3 are provided for electrical connection of a piezoelectric element P by soldering. The flexible portions 2 are clearly equipped with internal electrical connections connecting the contact pads 3 with the printed circuit of the rigid-flexible PCB 1, through their fixed end 2f. The intermediate part of the PCB flexible portions 2, i.e. that comprised between the fixed end 2f and the free end 2c, has a serpentine shape, specifically designed to give the piezoelectric element P soldered onto the contact pads 3 the greatest possible number of degrees of freedom and thus minimize the vibrations dampened by the flexible portions 2 of the PCB 1. Finally, two additional contact pads (not shown in the drawings), connected to the printed circuit in parallel to the contact pads 3, are provided on the rigid-flexible PCB 1, in the proximity of each flexible portion 2, for any manual repairs of the electrical connection between the piezoelectric element P and the rigid-flexible PCB 1 in the event of failures of said flexible electrical connection, as better illustrated below.

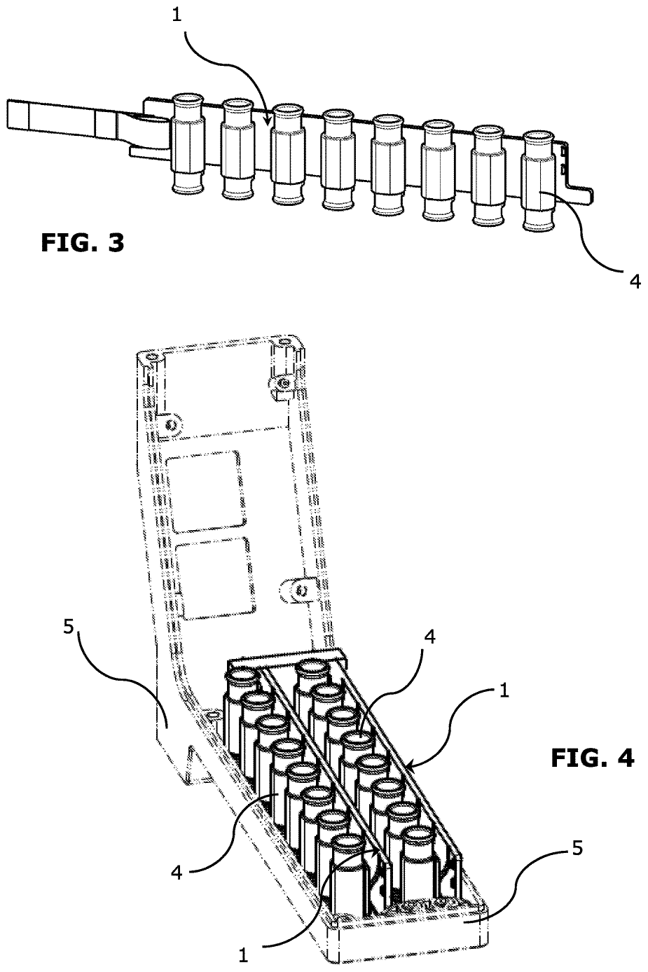

As will be more extensively described in the following, in a first step of the assembly method of the invention, piezoelectric elements P are placed on each rigid-flexible PCB 1 in correspondence with each of the flexible portions 2, and then a single automatic soldering operation is carried out between the contact pads 3 and the corresponding contact poles of the piezoelectric elements P which, as stated above, are both located on the surface of the piezoelectric elements P facing towards the rigid-flexible PCB 1 and therefore towards the surface of the free end 2c on which the contact pads 3 are provided. When the soldering has been completed, the rigid-flexible PCB 1 appears therefore as illustrated in FIG. 2. At this point, respective yarn guide eyelets 4 are glued onto the piezoelectric elements 3 and the thus completed rigid-flexible PCB 1 appears as illustrated in FIG. 3.

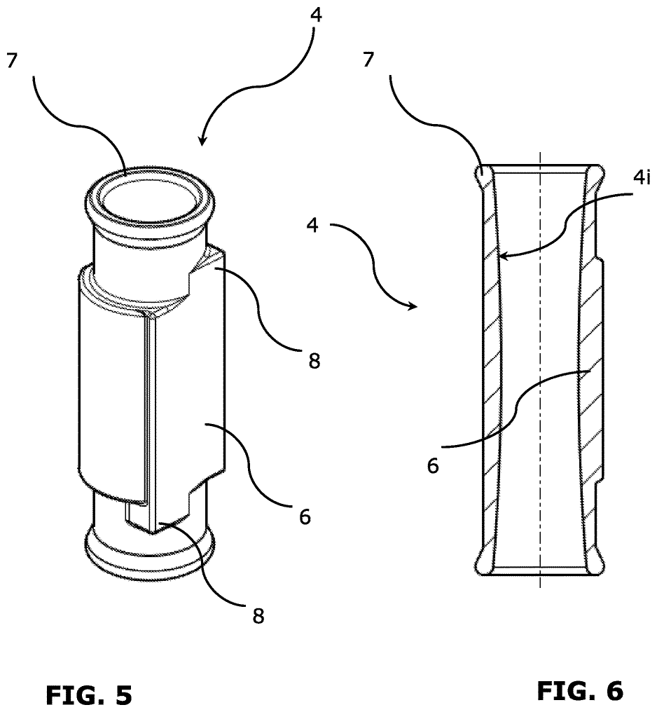

The yarn guide eyelets 4 used in the multiple piezoelectric yarn sliding sensor of the present invention have some shape innovations, clearly illustrated in the FIGS. 5 and 6, which are particularly useful for improving the performance of said sensor.

A first innovation concerns the inner profile (4i) of the yarn guide eyelet 4 which is continuously convex as can be clearly seen in the sectional view of FIG. 6—so as to form an inner surface of the yarn guide eyelet without sudden variations in inclination and having a section progressively decreasing from the opposite mouths to the centre thereof-which allows obtaining a larger contact surface with a yarn passing through the eyelet, even if the yarn entry direction forms an angle with respect to the axis of the yarn guide eyelet 4.

A second innovation concerns the shape of the circular mouth 7 of the yarn guide eyelet, which has a rounded annular protrusion towards the outside, to avoid that when the entry direction of a yarn forms an accentuated angle with respect to the axis of the yarn guide eyelet, the yarn can slide against a rubber seat which supports the yarn guide eyelets 4 and keeps them in a predetermined position inside a support shell.

A third innovation concerns the provision of a large flat outer wall 6 on one side of the yarn guide eyelet 4, preferably parallel to the axis of the yarn guide eyelet 4, to allow stable glueing of the same to a corresponding flat surface of the piezoelectric elements P. Finally, in a fourth innovation, the flat outer wall 6 also includes two longitudinal angular protrusions 8 which prevent the rotation of the yarn guide eyelet 4 about its axis, when the yarn guide eyelet 4 is inserted inside a respective rubber seat, wherein one or the other of said angular protrusions 8 engages.

The assembly method of the multiple piezoelectric yarn sliding sensor according to the present invention involves the following steps:
a) a step of SMT soldering the piezoelectric elements P onto the rigid-flexible PCB 1, wherein the piezoelectric elements P are placed using a “pick and place” positioning apparatus (hereinafter briefly referred to as “P&P”) on respective contact pads 3 provided at the free end 2c of the flexible portions 2 of the rigid-flexible PCB 1. Then, all the thus placed piezoelectric elements P are simultaneously soldered to the respective contact pads 3 in a reflow oven, in an identical manner to the well-known one for smd electronic components;
b) a step of glueing ceramic yarn guide eyelets 4 onto respective piezoelectric elements P already soldered to the flexible portions of the rigid-flexible PCB 1. The yarn guide eyelets 4 are placed by use of a specific P&P positioning apparatus in correspondence with the piezoelectric elements P already soldered to the rigid-flexible PCB 1, then provided with a layer of glue, and finally made to adhere to the piezoelectric elements P as illustrated in FIG. 3;
b1) a possible step of cutting the rigid-flexible PCB 1 from a multiple board. To facilitate the handling of rigid-flexible PCBs 1 in automatic processing machines, larger multiple boards are often used, which thus contains multiple PCBs 1 on each multiple board. In this case, at the end of step b) each rigid-flexible PCB 1 is cut from said multiple board by a router. During the cutting step, each single yarn guide eyelet 4 is kept blocked with special grippers, to avoid undue stress on the flexible portions 2 of the rigid-flexible PCB 1;
c) a step of mechanical assembly of rigid-flexible PCBs 1, complete with piezoelectric elements P and yarn guide eyelets 4, in a specific support shell 5 (hatched in FIG. 4), wherein usual rubber seats have already been inserted for housing the yarn guide eyelets 4. In the illustrated embodiment, two rigid-flexible PCBs 1 are mounted on respective seats provided in the support shell 5 and then individual yarn guide eyelets 4 are inserted into their adjacent rubber seats, by detaching the respective flexible portions 2 from the rigid-flexible PCB 1, except for the fixed end 2f. The flexible portions 2 thus form an electrical connection with multiple degrees of freedom between the rigid-flexible PCB 1 and the yarn guide eyelet 4/piezoelectric element P assembly which therefore allows said assembly to freely vibrate when a yarn passes through the yarn guide eyelet 4.

This result was achieved using a fully automatic assembly method and without the need for any manual soldering. In the event of damage or breakage of a flexible portion 2 during use, the same can be easily replaced by a pair of flexible conductors which are manually soldered to the piezoelectric element and to said additional contact pads provided on the rigid substrate of the rigid-flexible PCB 1, therefore without the need to replace the entire multiple piezoelectric yarn sliding sensor. All the intended objects of the present invention have therefore been achieved.

However, it is understood that the invention should not be considered as limited to the specific arrangements illustrated above, which are only exemplary embodiments thereof, but that different variants are possible, all within the reach of a person skilled in the art, without thereby departing from the scope of protection of the invention itself, which is only defined by the following claims.

1. Multiple piezoelectric yarn sliding sensor including a plurality of individual piezoelectric sensors, each comprising a piezoelectric element (P) stably associated with a yarn guide eyelet (4), an electronic printed circuit board onto which the electrical signals emitted by the piezoelectric elements (P) of said individual piezoelectric sensors are conveyed, and electrical connections between said piezoelectric elements (P) and said electronic printed circuit board, wherein said electronic printed circuit board (1) includes flexible portions (2) partially detachable from the electronic printed circuit board (1) with a free end (2c) thereof and said electrical connections comprise said flexible portions (2).

2. The multiple piezoelectric yarn sliding sensor according to claim 1, wherein said piezoelectric element (P) is provided with two metallized poles for electrical connection and said two metallized poles are arranged on a same surface of the piezoelectric element (P).

3. The multiple piezoelectric yarn sliding sensor according to claim 2, wherein said flexible portions (2) of the electronic printed circuit board (1) are provided with two contact pads (3) on a surface of said free end (2c), for an electrical connection of said piezoelectric elements (P).

4. The multiple piezoelectric yarn sliding sensor according to claim 3, wherein an intermediate part of each flexible portion (2) of the electronic printed circuit board (1), comprised between a fixed end thereof (2f) and said free end (2c), is serpentine shaped.

5. The multiple piezoelectric yarn sliding sensor according to claim 3, wherein two additional contact pads connected to the printed circuit in parallel to said contact pads (3) are provided on the electronic printed circuit board (1), in the proximity of each flexible portion (2).

6. The multiple piezoelectric yarn sliding sensor according to claim 1, wherein said yarn guide eyelet (4) has a continuously convex inner profile (4i) so that its inner surface has no sudden variations in inclination and has a section progressively decreasing from the opposite mouths to the centre thereof.

7. The multiple piezoelectric yarn sliding sensor according to claim 1, wherein the shape of a circular mouth (7) of said yarn guide eyelet (4) includes an outer rounded annular protrusion.

8. The multiple piezoelectric yarn sliding sensor according to claim 1, wherein one side of said yarn guide eyelet (4) includes a flat outer wall (6) for glueing to a corresponding flat surface of said piezoelectric element (P).

9. The multiple piezoelectric yarn sliding sensor according to claim 8 wherein said flat outer wall (6) is parallel to the axis of said yarn guide eyelet (4) and includes at least one longitudinal angular protrusion (8) suitable for engaging within a rubber support seat of said yarn guide eyelet (4).

10. Method for automatic assembly of a multiple piezoelectric yarn sliding sensor, of the type including a plurality of individual piezoelectric sensors, each comprising a piezoelectric element (P) stably associated with a yarn guide eyelet (4), an electronic printed circuit board which processes the electrical signals emitted by the piezoelectric elements (P) of said individual piezoelectric sensors and electrical connections between said piezoelectric elements (P) and said electronic printed circuit board, wherein it the method includes the following steps:
a. a soldering step by means of surface mount technology (SMT), wherein metallized poles of several piezoelectric elements (P) are soldered on respective flexible portions (2) of an electronic printed circuit board (1) which includes flexible portions (2) partially detachable from the electronic printed circuit board (1) with a free end thereof (2c), and provided with contact pads (3) for an electrical connection of said piezoelectric elements (P); and
b. a glueing step, wherein yarn guide eyelet (4) are glued onto said piezoelectric elements (P) soldered to said rigid-flexible electronic printed circuit board (1) in step a).

11. The method for automatic assembly of a multiple piezoelectric yarn sliding sensor according to claim 10, wherein said piezoelectric elements are each provided with two metallized poles for electrical connection and said two metallized poles are arranged on a same surface of the piezoelectric element (P).

12. The method for automatic assembly of a multiple piezoelectric yarn sliding sensor according to claim 11, wherein said flexible portions (2) of the electronic printed circuit board (1) are provided with contact pads (3) on a surface of their free end (2c), for an electrical connection of said piezoelectric elements (P).

13. The method for automatic assembly of a multiple piezoelectric yarn sliding sensor according to claim 12, wherein in said soldering step a) said piezoelectric elements (P) are placed on said contact pads (3) by means of a “pick and place” positioning apparatus and then simultaneously soldered to the same.

14. The method for automatic assembly of a multiple piezoelectric yarn sliding sensor according to claim 12, wherein in said glueing step b) said yarn guide eyelets (4) are placed in correspondence with said piezoelectric elements (P) soldered to the electronic printed circuit board (1) by means of a “pick and place” positioning apparatus, provided with a layer of glue and then made to adhere to said piezoelectric elements (P).

15. The method for automatic assembly of a multiple piezoelectric yarn sliding sensor according to claim 12, wherein an intermediate part of each flexible portion (2) of the electronic printed circuit board, comprised between a fixed end thereof (2f) and said free end (2c), is serpentine shaped.

16. The method for automatic assembly of a multiple piezoelectric yarn sliding sensor according to claim 14, wherein said yarn guide eyelets (4) include a flat outer wall (6) for glueing to a corresponding flat surface of said piezoelectric element (P).

17. The method for automatic assembly of a multiple piezoelectric yarn sliding sensor according to claim 10, where the following additional step is provided:
c) a mounting step wherein said electronic printed circuit board (1), complete with piezoelectric elements (P) and yarn guide eyelets (4), is mechanically mounted in a respective seat of a support shell (5) wherein
i. said electronic printed circuit board (1) is mounted in a first seat, and
ii. said yarn guide eyelets (4) are mounted in a second seat, separate from said first seat and adjacent thereto, partially detaching the free ends (2c) of said flexible portions (2) from said electronic printed circuit board (1).

18. The method for automatic assembly of a multiple piezoelectric yarn sliding sensor according to claim 17, wherein said second seat is made of rubber and said yarn guide eyelets (4) are provided with a flat outer wall (6), parallel to the axis of said yarn guide eyelet (4), which includes at least one longitudinal angular protrusion (8) engaging within said second seat.
